(19) United States
(12) Patent Application Publication
(10) Pub. No.: US 2011/0136387 A1
(43) Pub. Date: Jun. 9, 2011

(54) CARD EDGE CONNECTOR

(75) Inventors: Naoya Matsuura, Kanagawa (JP); Toshiya Oda, Kanagawa (JP); Kotaro Kobayashi, Kanagawa (JP)

(73) Assignee: MOLEX INCORPORATED, Lisle, IL (US)

(21) Appl. No.: 12/997,029

(22) PCT Filed: Jun. 9, 2009
(86) PCT No.: PCT/US09/46707

§ 371 Date: Feb. 25, 2011

(30) Foreign Application Priority Data
Jun. 9, 2008 (JP) 2008-150560

(51) Int. Cl. H01R 24/00

(52) U.S. Cl. 439/636

(57) ABSTRACT

A connector comprises a housing, a lever and a lock portion. The housing receives terminals. The lever is rotatably attached to the housing, and is configured to be rotatable between a first position, where an initial stage of fitting of the connector to a counterpart connector is established, and a second position, where the fitting thereof to the counterpart connector is completed. The lock portion is capable of locking the lever at the second position. The lock portion is slidably attached to a body portion of the lever, and is configured to be slid between a lock position where the lever is locked and a lock release position where the lever is released. The lever is provided with a positioning latch-portion that is configured to latch the lock portion at the lock position and the lock release position. The positioning latch-portion is provided with a concaved latch-portion and a convexed latch-portion that is configured to be elastically displaced to be engaged in or disengaged from the concaved latch-portion.

### BACKGROUND OF THE INVENTION

1. Field of the Invention

The Present Invention relates generally to a card edge connector, and, more particularly, to a card edge connector in which a plurality of contact portions are formed on opposed terminals, thereby preventing the contact portions from being damaged or contaminated by foreign substances on the tip of the card.

2. Description of the Related Art

Hitherto, a card edge connector has been used as a direct type connector of the type in which a card edge that is a tip of a board such as a printed circuit board, namely, a card, is directly inserted as a plug part to accomplish fitting (for example, refer to Japanese Patent Application Laid-Open (Kokai) 09-148009).

FIGS. 12A, 12B and 12C are cross-sectional views of a conventional card edge connector. FIG. 12A illustrates a connector main body in a state thereof prior to insertion of a board therein. FIGS. 12B and 12C illustrate a state where a terminal of the connector is in contact with the board, respectively.

As shown in FIG. 12A, the card edge connector has a housing 811 made of an insulating material such as a synthetic resin and a plurality of terminals 851 made of a conductive material such as a metal and held by the housing 811. Each of tail portions 852 of the terminal 851 protrudes downward from the bottom surface of the housing 811. The tail portion 852 is inserted into a through hole in a motherboard (not shown) and is soldered thereto.

The housing 811 includes a rectangular long groove-like recess part 813 opened at an upper surface thereof. An edge portion 911 of a board or a card 901 is inserted into the recess part 813. The housing 811 also includes a plurality of slits 814 arranged orthogonally to the longitudinal direction of the recess part 813. The portions close to the tips of the paired terminals 851 are arranged to oppose to each other inside the slit 814. Two bent convex parts, that is, a contact portion 854a and a wiping portion 854b arranged to protrude in the direction toward the center of the housing 811 are formed on the portion close to the tip of each terminal 851.

When the edge portion 911 of the card 901 is inserted into the recess part 813 of the housing 811, the wiping portion 854b of the terminal 851 rubs against a pad 951 formed on the surface of the card 901 while being pressed against the same prior to the contact portion 854a as shown in FIG. 12B. This removes, as shown in FIG. 12C, foreign substances 991 attached to the surface of the pad 951, such as dust, dirt and an oxide film by way of the wiping effect by the wiping portion 854b, thereby causing the contact portion 854a to come into contact with the center portion of the pad 951. This ensures that the terminal 851 and the pad 951 are electrically connected with each other without intervention of any foreign substance 991 between the contact portion 854a and the pad 951.

Nevertheless, with the conventional card edge connector, the contact portion 854a of the terminal 851, together with the wiping portion 854b, rubs against the tip of the edge portion 911 while being pressed against the same when the edge portion 911 of the card 901 is inserted into the recess part 813 of the housing 811. As a result, the surface of the contact portion 854a may be abraded or glass fibers or the like may attach to the surface of the contact portion 854a, thus degrading the contact between the contact portion 854a and the pad 951 and electrically isolating the terminal 851 from the pad 951.

As shown in FIGS. 12B and 12C, in general, chamfered portions, each being a tilted surface is formed at a tip of the edge portion 911 of the card 901 so that the tip will be smoothly inserted into the recess part 813 of the housing 811. Glass fibers or the like as the parent material of the card 901 are exposed on the chamfered portions. When the contact portion 854a rubs against the corresponding chamfered portion of the edge portion 911 while being pressed against the same, a conductive plating film formed on the surface of the contact portion 854a is abraded or foreign substances such as glass fibers adhere to the surface of the contact portion 854a and are interposed between the contact portion 854a and the pad 951. This degrades the contact between the contact portion 854a and the pad 951.

The foreign substances such as glass fibers also attach to the surface of the wiping portion 854b. When the wiping portion 854b rubs against the pad 951 while being pressed against the same, foreign substances such as glass fibers attach to the surface of the pad 951 to contaminate the surface of the pad 951 and come to be interposed between the contact portion 854a and the pad 951. This may result in degrading the contact between the contact portion 854a and the pad 951.

### SUMMARY OF THE INVENTION

Therefore, an object of the present invention is to solve the above-mentioned problems encountered by the conventional card edge connector through provision of a reliable card edge connector in which a plurality of contact portions are formed on opposed terminals, and one of the contact portions that is disposed closer to a fitting end of a connector main body comes into contact with a tip of a card being inserted and only the other of the contact portions come into contact with the connecting electrodes of the card, thereby preventing the connecting electrodes and the other contact portion or portions from being contaminated by foreign substances on the tip of the card and preventing the other contact portion or portions from being damaged, maintaining a good contacting state between the other contact portions and the connecting electrodes, and ensuring electric connection between the terminals and the connecting electrodes while offering high durability.

In order to achieve the above-mentioned object, the present invention provides a card edge connector comprising a connector main body configured to be fitted with a card provided with connecting electrodes and terminals loaded in the connector main body, each being configured to include a plurality of contact portions capable of coming into contact with the card, wherein respective of the contact portions are arranged to form rows opposed to each other, and wherein, when the contact portions out of the plurality of contact portions which are disposed closer to a fitting end of the connector main body with the card are in contact with a tip portion of the card, the other contact portions are not in contact with the same tip portion, and when the other contact portions are in contact with the connecting electrodes of the card, the contact portions disposed closer to the fitting end is not in contact with the same connecting electrodes.

In accordance with another embodiment of the present invention, the card edge connector is provided, wherein the plurality of contact portions of each of the terminals are arranged in a front-and-rear direction of the connector main body, and wherein in comparison with an amount of protrusion of the contact portion which is disposed to the fitting end of the main connector main body with the card, that of protrusion of the other contact portion is configured to be larger.

In accordance with a further embodiment of the present invention, the card edge connector is provided, wherein the terminal comprises a main body secured to the connector main body, a cantilever-like arm part configured to extend obliquely from one end of the main body, and the plurality of contact portions formed in a free end part of the arm part.

In accordance with a still further embodiment of the present invention, the card edge connector is provided, wherein each of the plurality of contact portions comprises a part of a swelling portion formed at a bent portion, which is bent so as to protrude toward a center of the connector main body in a thickness direction thereof and is formed at the free end part of the arm part.

In accordance with a still further embodiment of the present invention, the card edge connector is provided, wherein at least a surface of the other contact portion out of the plurality of contact portions us formed therein with a film having a good conductivity.

In accordance with a still further embodiment of the present invention, the card edge connector is provided, wherein the plurality of contact portions comprises a first contact portion and a second contact portion.

In accordance with the present invention, the card edge connector is configured so that a plurality of contact portions are formed in opposing terminals and only the contact portions disposed closer to a fitting end of a connector main body come into contact with the tip of a card and only the other contact portions come into contact with the connecting electrodes of the card. This prevents the connecting electrodes and the other contact portions from being contaminated by foreign substances on the tip of the card and also prevents the other contact portions from being damaged, maintains a good connection state between the other contact portions and the connecting electrodes, and ensures electric connection between the terminals and the connecting electrodes while offering a high durability of the card edge connector.

### BRIEF DESCRIPTION OF THE FIGURES

The organization and manner of the structure and operation of the Present Invention, together with further objects and advantages thereof, may best be understood by reference to the following Detailed Description, taken in connection with the accompanying Figures, wherein like reference numerals identify like elements, and in which:

FIG. 1 is a perspective view illustrating a state before fitting of a card edge connector with a card and a counterpart connector, according to an embodiment of the present invention;

FIG. 2 is a perspective view illustrating a state after fitting of the card edge connector with the card and the counterpart connector, according to the embodiment of the present invention;

FIG. 3A is a cross-sectional view of a card edge connector, illustrating a state before fitting of the card edge connector with the card and the counterpart connector according to the embodiment of the present invention;

FIG. 3B is a cross-sectional view of the card edge connector, illustrating a state after fitting of the card edge connector with the card and the counterpart connector according to the embodiment of the present invention;

FIG. 4A is a front view of the card edge connector according to the embodiment of the present invention;

FIG. 4B is a top view of the card edge connector according to the embodiment of the present invention;

FIG. 4C is a rear view of the card edge connector according to the embodiment of the present invention;

FIG. 4D is a side view of the card edge connector according to the embodiment of the present invention;

FIG. 4E is a perspective view of the card edge connector according to the embodiment of the present invention;

FIG. 5 is an exploded view of the card edge connector according to the embodiment of the present invention;

FIG. 6 is an enlarged side view of an important part of a terminal of the card edge connector according to the embodiment of the present invention;

FIGS. 7A to 7D are cross-sectional views illustrating a sequence of movements for fitting the card edge connector with the card, according to the embodiment of the present invention;

FIG. 8 is a first view illustrating a positional relationship between the terminal of the card edge connector and the card, according to the embodiment of the present invention;

FIG. 9 is a second view illustrating a positional relationship between the terminal of the card edge connector and the card, according to the embodiment of the present invention;

FIG. 10 is a third view illustrating a positional relationship between the terminal of the card edge connector and the card, according to the embodiment of the present invention;

FIG. 11 is a fourth view illustrating a positional relationship between the terminal of the card edge connector and the card, according to the embodiment of the present invention; and

FIG. 12A is a cross-sectional view of a conventional card edge connector, illustrating a state of a connector main body before a board is inserted;

FIGS. 12B and 12C are cross-sectional views of the conventional card edge connector, illustrating a state where one of terminals is in contact with the board.

### DESCRIPTION OF THE PREFERRED EMBODIMENTS

While the Present Invention may be susceptible to embodiment in different forms, there is shown in the Figures, and will be described herein in detail, specific embodiments, with the understanding that the discussion herein is to be considered an exemplification of the principles of the Present Invention, and is not intended to limit the Present Invention merely to that as illustrated. Further, in the embodiments illustrated in the Figures, representations of directions such as up, down, left, right, front, rear and the like, used for explaining the structure and movement of the various elements of the Present Invention, are not absolute, but relative. These representations are appropriate when the elements are in the position shown in the Figures. If the description of the position of the elements changes, however, it is assumed that these representations are to be changed accordingly.

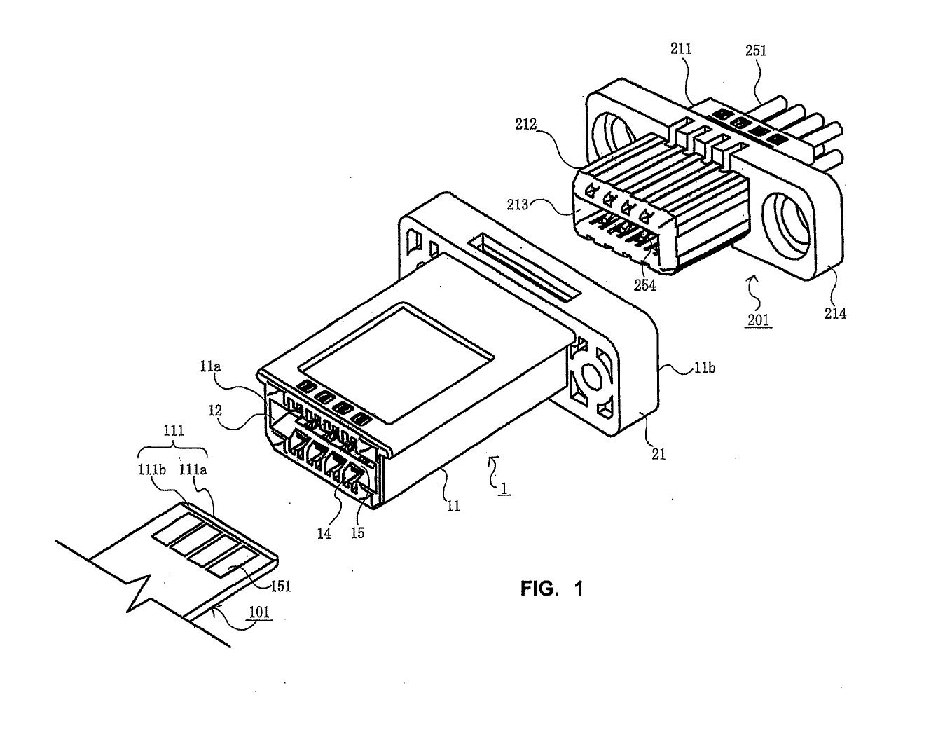

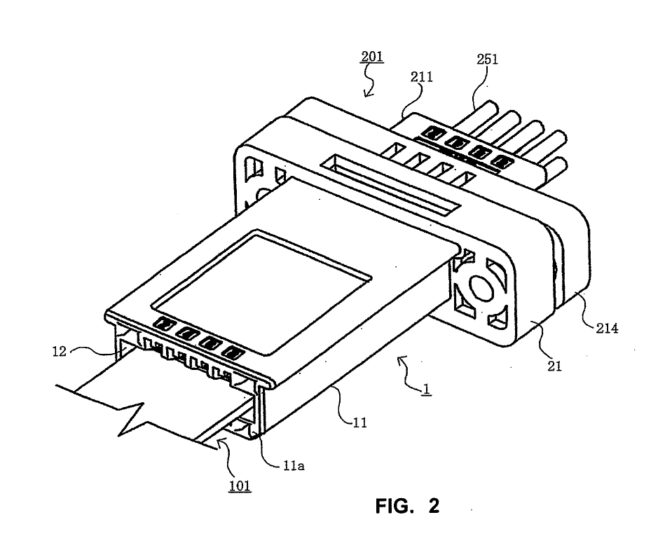

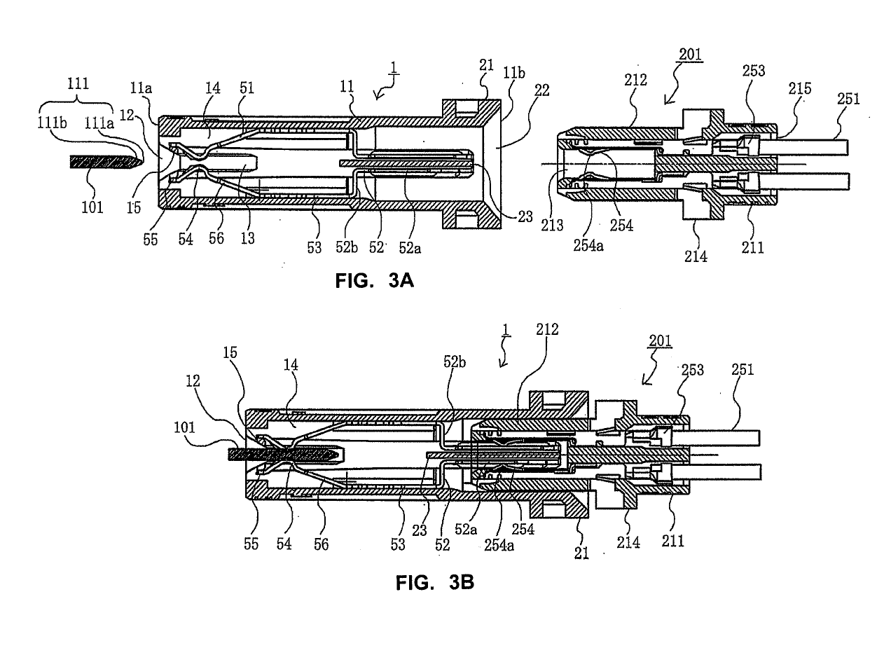

Preferred embodiments of the present invention will be hereinafter described in detail with reference to the accompanying drawings. FIG. 1 is a perspective view illustrating a card edge connector in the state thereof before being fitted with a card and a counterpart connector, according to an embodiment of the present invention. FIG. 2 is a perspective view of the card edge connector in the state thereof after being fitted with the card and the counterpart connector, according to the embodiment of the present invention. FIGS. 3A and 3B are cross-sectional views illustrating the card edge connector in the state thereof before and after being fitted with the card and the counterpart connector, respectively, according to the embodiment of the present invention.

In the drawing figures, a connector as a card edge connector according to an embodiment of the present invention is generally represented by reference numeral 1 and is provided with one end thereof (a left end in FIG. 3) to which a card 101 as a board is fitted and the other end thereof (a right end in FIG. 3) to which a counterpart connector 201 is fitted.

The card 101 may be a printed circuit board used in an electronic device such as a computer, or an electric appliance such as a home electronics product, an FPC (Flexible Printed Circuit), or a flat cable called an FFC (Flexible Flat Cable) or the like, a memory card, or of any other type. In this example, the card 101 is assumed to be comprised of a printed circuit board throughout the description.

A plurality of connecting electrodes 151 having a flat plate shape, respectively, and arranged at a predetermined pitch along a tip edge 111a are exposed on both the upper and lower surfaces of the card 101. The respective connecting electrodes 151 are electrically connected to a conductive trace (not shown) of the card 101. A film having a good conductivity made of a substance having a good conductivity such as gold may be formed by way of plating or the like on the surface of the connecting electrodes 151, as required. While four connecting electrodes 151 are arranged on each surface of the card 101 in the illustrated example, it is possible to arbitrarily set the number and the pitch of the connecting electrodes 151. In each of portions adjacent to the tip edge 111a on each of the upper and lower surfaces of the card 101 is formed a tapered surface 111b inclining rearward. A portion comprised of the tip edge 111a and the tapered surfaces 111b on both sides is called a tip portion 111 of the card 101. As shown in FIG. 3, the tip portion 111 has a cross section converging toward the tip thereof which allows smooth insertion into the connector 1.

The counterpart connector 201 is a connector to which the end of each of conductors 251 such as a coaxial cable is connected. The conductor 251 connected is not necessarily a coaxial cable but a flat cable such as an FPC or FFC. While eight conductors 251 are used in the illustrated example, the number of the conductors 251 may be arbitrarily set as required.

In this embodiment, representations of directions such as up, down, left, right, front, rear and the like, used for explaining the structure and movement of each part of the connector 1, the card 101, the counterpart connector 201 and other members are not absolute, but relative. These representations are appropriate when each part of the connector 1, the card 101, the counterpart connector 201 and other members is in the position shown in the figures. If the position of the connector 1, the card 101, the counterpart connector 201 and other members changes, however, it is assumed that these representations are to be changed according to the change of the connector 1, the card 101, the counterpart connector 201 and other members in the position.

The connector 1 includes a housing 11 as a connector main body integrally formed of an insulating material such as a synthetic resin and a plurality of terminals 51 formed of a conductive metal and loaded in the housing 11. The housing 11 is a member in the shape of a substantially rectangular parallelepiped body and includes a front recess part 12 formed to be opened at a fitting end to the card 101, that is, at the end face of a front end (the left end in FIG. 3) 11a and a rear recess part 22 formed to be opened at a fitting end to the counterpart connector 201, that is, at the end face of a rear end (the right end in FIG. 3) 11b. The rear end 11b includes a collar-shaped flange part 21 integrally connected thereto.

A slit-shaped card-accommodating groove part 13 opened toward the front end 11a of the housing 11 and configured to extend in the direction of width of the housing 11 is arranged inside the front recess part 12. A plurality of terminal-accommodating groove parts 14 opened in the upper and lower faces of the card-accommodating groove part 13 is also arranged inside the front recess part 12. Four of the terminal-accommodating groove parts 14 are arranged on each of the upper and lower faces of the card-accommodating groove part 13 side by side in the direction of width of the housing 11. One terminal 51 is accommodated and loaded in each of the terminal-accommodating groove parts 14 in the example shown in FIG. 1. Each terminal-accommodating groove part 14 extends in a front-and-rear direction of the housing 11 (a horizontal direction in FIG. 3). When the card 101 is inserted and fitted into the card-accommodating groove part 13, the terminal 51 in each terminal-accommodating groove part 14 is configured to come into contact with the corresponding connecting electrode 151 of the card 101. The number and pitch of the terminal-accommodating groove part 14 may be changed as appropriate to match the number and pitch of the connecting electrodes 151. The terminals 51 need not always be loaded in every terminal-accommodating groove part 14. Some of the terminals 51 may be omitted as appropriate to match the array of the connecting electrodes 151 of the card 101.

A preload imparting portion 15 configured to extend in the direction of width of the housing 11 is arranged on each of the upper and lower sides of the front end of the card-accommodating groove part 13 in the front recess part 12. The preload imparting portion 15 is formed to cross the front end of each terminal-accommodating groove part 14. In a state where the card 101 is not inserted in the card-accommodating groove part 13, a tip portion 55 of the terminal 51 accommodated in each terminal-accommodating groove part 14 is engaged with the preload imparting portion 15. This imparts a preload to the terminal 51. The spacing between the upper and lower preload imparting portions 15 is set larger than the vertical dimension of the card 101, namely, a thickness dimension thereof.

Furthermore, a plate-shaped terminal supporting plate part 23 configured to extend in the direction of width of the housing 11 is arranged inside the rear recess part 22. A tail contact portion 52a as a counterpart connector contact portion of each terminal 51 is arranged on each of the upper and lower surfaces of the terminal supporting plate part 23. Each tail contact portion 52a extends in the front-and-rear direction of the housing 11. When the counterpart connector 201 is inserted into the rear recess part 22, each tail contact portion 52a comes into contact with a corresponding counterpart terminal 254 of the counterpart connector 201.

In this embodiment, the counterpart connector 201 has a counterpart housing 211 integrally formed of an insulating material such as a synthetic resin and a plurality of counterpart terminals 254 made of a conductive metal and loaded in the counterpart housing 211. The counterpart housing 211 is a member in the shape of a substantially rectangular parallelepiped body and includes an integrally connected collar-shaped counterpart flange part 214 and a fitting convex part 212 configured to extend frontward (leftward in FIG. 3) from the counterpart flange part 214 and inserted into the rear recess part 22 of the connector 1.

A fitting recess part 213 formed to be opened at the end face of the fitting end to the connector 1, namely, at the end face of the front end (the left end in FIG. 3) is formed at the fitting convex part 212. A conductor insertion opening 215 opened at the end face of the end opposite to the fitting end, that is, at the end face of the front end (the right end in FIG. 3) is formed on the counterpart housing 211. The tip of each conductor 251 is accommodated in the conductor insertion opening 215. A conductor terminal 253 is connected to the tip of each of the conductors 251. The conductor terminals 253 are connected to the corresponding counterpart terminals 254. The counterpart terminals 254 are arranged along the inner surface of each of the upper and lower sides of the fitting recess part 213. This electrically connects each conductor 251 to each of the counterpart terminals 254 arranged in the fitting recess part 213. Furthermore, a counterpart contact portion 254a of the counterpart terminal 254 protrudes inwardly than each of the upper and lower inner side surfaces of the fitting recess part 213.

When the connector 1 is fitted to the counterpart connector 201, the fitting convex part 212 of the counterpart connector 201 is inserted into the rear recess part 22 of the connector 1 and the terminal supporting plate part 23 is inserted into the fitting recess part 213 of the fitting convex part 212. This causes each of the tail contact portions 52a arranged on the upper and lower surfaces of the terminal supporting plate part 23 to come into contact with the counterpart contact portion 254a of the corresponding counterpart terminal 254 arranged along each of the upper and lower inner side surfaces of the fitting recess part 213. In this case, the terminal supporting plate part 23 is inserted between the counterpart contact portions 254a on both sides, which increases a spacing between the counterpart contact portions 254a on both sides and causes the counterpart terminals 254 to be elastically deformed thereby producing an elastic urging force which presses the counterpart contact portion 254a against the tail contact portion 52a. This reliably maintains the electrical connection between the terminal 51 and the counterpart terminal 254. The counterpart contact portions 254a on both sides sandwich the terminal supporting plate part 23, so that the fitting between the connector 1 and the counterpart connector 201 is reliably maintained.

The terminal 51 has a main body 53 configured to extend linearly in the front-and-rear direction of the housing 11 and fixedly disposed inside the terminal-accommodating groove part 14, a tail portion 52 configured to extend rearward from the rear end of the main body 53, and an arm part 56 configured to extend frontward from the front end of the main body 53. The tail portion 52 includes a tail connecting part 52b bent substantially orthogonal to the main body 53 and a tail contact portion 52a configured to be bent substantially orthogonal to the tail connecting part 52b and configured to extend rearward in parallel with the main body 53. As described above, the tail contact portions 52a are arranged on the upper and lower surfaces of the terminal supporting plate part 23 and come into contact with the corresponding counterpart terminals 254 of the counterpart connector 201.

The arm part 56 is a cantilever-like elastic plate member configured to extend obliquely frontward and is inclined toward the center of the housing 11 in a thickness direction from the front end of the main body 53. A bent portion 54 as a contact portion bent so as to protrude toward the center of the housing 11 in its thickness direction and a tip portion 55 configured to extend frontward from the front end of the bent portion 54 are formed in a free end, namely, the front end of the arm part 56. The tip portion 55 is engaged with the preload imparting portion 15.

Assuming that no preload imparting portion 15 exists, in a state where the card 101 is not inserted in the card-accommodating groove part 13, the front end of the arm part 56 would be in a position closer to the center of the thickness direction of the housing 11 than the position shown in FIG. 3A. To the contrary, when the tip portion 55 is engaged with the preload imparting portion 15, the arm part 56 is elastically deformed so that the front end thereof is displaced vertically, or in other words, the arm part 56 is placed in a state where a predetermined pressure, namely, a preload is imparted thereto.

In a state where the card 101 is not inserted in the card-accommodating groove part 13, that is, in the initial state, the spacing between the upper and lower bent portions 54 opposing to each other is set smaller than the thickness dimension of the card 101. The card 101 inserted into the card-accommodating groove part 13 advances between the upper and lower bent portions 54 opposing to each other, which increases the spacing between the bent portions 54 and causes the arm part 56 to be elastically deformed. The resulting urging force presses each of the bent portions 54 against the corresponding connecting electrode 151 on the upper or lower surface of the card 101. This reliably maintains the electrical connection between the terminal 51 and the connecting electrode 151. The upper and lower bent portions 54 sandwich therebetween the card 101 so that the fitting between the connector 1 and the card 101 is reliably maintained. The contact state between the bent portion 54 and the connecting electrode 151 will be later described in detail.

Next, the construction and arrangement of the connector 1 will be described in detail hereinbelow.

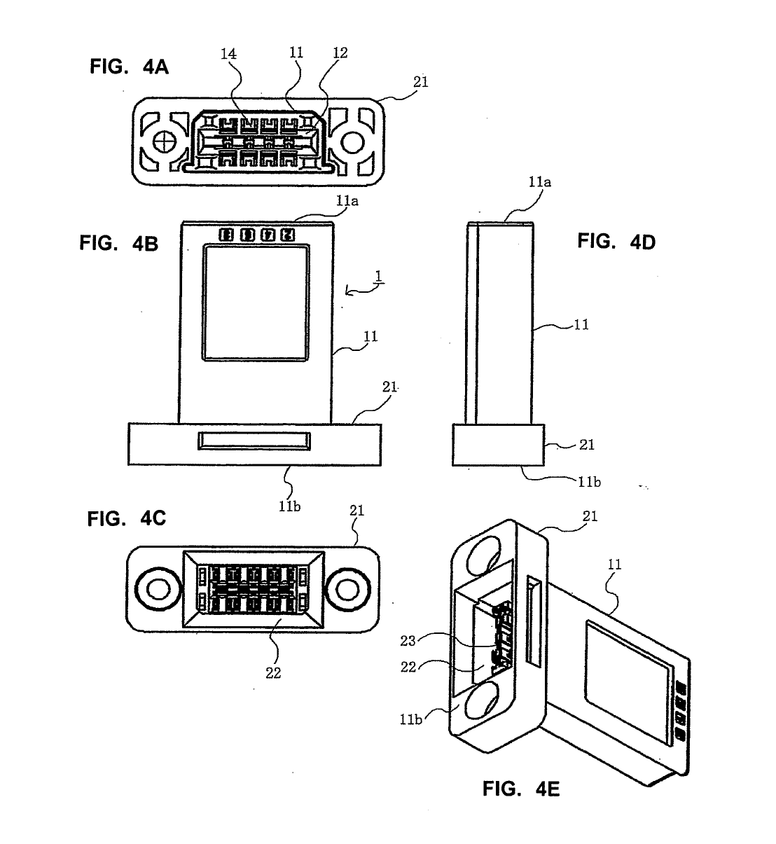

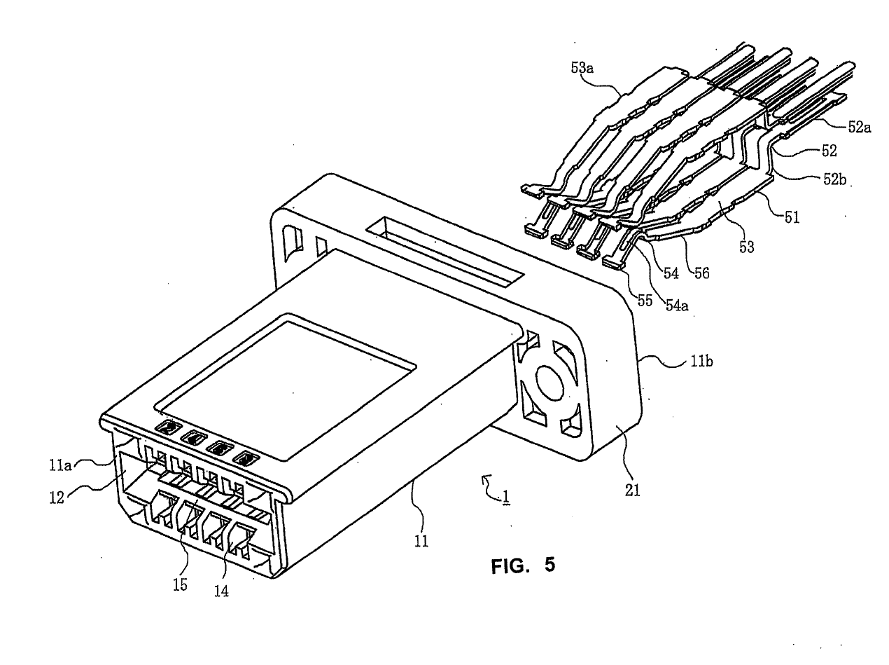

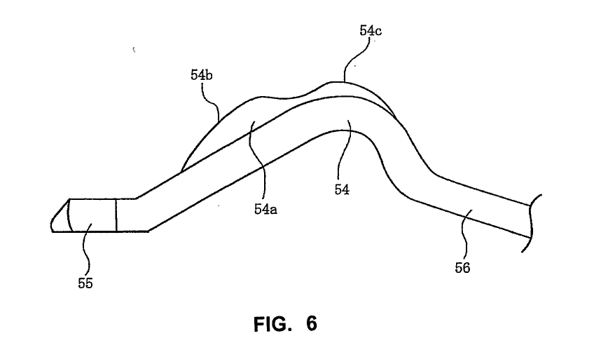

FIG. 4A is a front view of the card edge connector according to the embodiment of the present invention. FIG. 4B is a top view of the card edge connector according to the embodiment of the present invention. FIG. 4C is a rear view of the card edge connector according to the embodiment of the present invention. FIG. 4D is a side view of the card edge connector according to the embodiment of the present invention. FIG. 4E is a perspective view of the card edge connector according to the embodiment of the present invention. FIG. 5 is an exploded view of the card edge connector according to the embodiment of the present invention. FIG. 6 is an enlarged side view of an important part of a terminal of the card edge connector, according to the embodiment of the present invention.

As shown in FIG. 4, four of the terminal-accommodating groove parts 14 are arranged side by side in a direction of width of the housing 11 on each of the upper and lower surfaces of the card-accommodating groove part 13. Thus, the terminals 51 accommodated and loaded in the terminal-accommodating groove parts 14 are also arranged side by side in the direction of width of the housing 11 as shown in FIG. 5.

A locking projection 53a is formed on each of the edges of the main body 53 of the terminal 51. The locking projection 53a is engaged into each of the inner wall walls on both sides of each terminal-accommodating groove part 14 to fix the main body 53 in the terminal-accommodating groove part 14.

As shown in FIG. 5, the bent portion 54 formed by bending the front end of the arm part 56 as a plate member has a bulge-like swelling portion 54a formed therein further swelling in an outer direction of the bent surface. The portion of the terminal 51 loaded in the housing 11 and configured to protrude furthest toward the center of the housing 11 in its thickness direction is the swelling portion 54a. Thus, the swelling portion 54a comes into contact with the card 101 inserted into the card-accommodating groove part 13.

When observed more microscopically, as shown in FIG. 6, two apex portions, namely, a first apex portion 54b and a second apex portion 54c are formed side by side on the swelling portion 54a in the front-and-rear direction of the housing 11. When the terminals 51 are loaded so as to be arranged up and down while opposing vertically to each other within the housing 11, the first apex portions 54b and the second apex portions 54c are arranged so as to form rows that oppose to each other. In FIG. 6, only one of the paired terminals 51 arranged vertically while opposing to each other is shown and the other is not shown. The first apex portion 54b and the second apex portion 54c are the portions protruding furthest toward the center of the housing 11 in its thickness direction on the swelling portion 54a of the terminal 51 loaded in the housing 11. Thus, the first apex portion 54b and the second apex portion 54c come into contact with the card 101 inserted in the card-accommodating groove part 13 and respectively function as a first contact portion and second contact portion of the terminal 51.

The second apex portion 54c protrudes further toward the center of the housing 11 in its thickness direction than the first apex portion 54b. In other words, the amount of protrusion of the second apex portion 54c is larger than that of the first apex portion 54b although the first apex portion 54b is positioned closer to the tip portion 55 than the second apex portion 54c. Thus, only the first apex portion 54b comes into contact with a tip portion 111 of the card 101 inserted into the card-accommodating groove part 13 and the second apex portion 54c does not. When the first apex portion 54b comes into contact with the connecting electrode 151 of the card 101, the second apex portion 54c comes into contact with a local portion of the tip portion 111. When the card 101 is inserted further, only the second apex portion 54c comes into contact with the connecting electrode 151 of the card 101 and the first apex portion 54b does not. While the difference between the protrusion amount of the first apex portion 54b and that of the second apex portion 54c is, for example, 0.15 [mm], an arbitrary value may be set as required. A film having a good conductivity made of a substance having a good conductivity such as gold may be formed by way of plating or the like on the surface of the swelling portion 54a or at least on the surface of the second apex portion 54c, as required.

Next, a description of the movement of fitting the connector 1 to the card 101 will be provided below. The movement of fitting the connector 1 to the counterpart connector 201 will not be described herein.

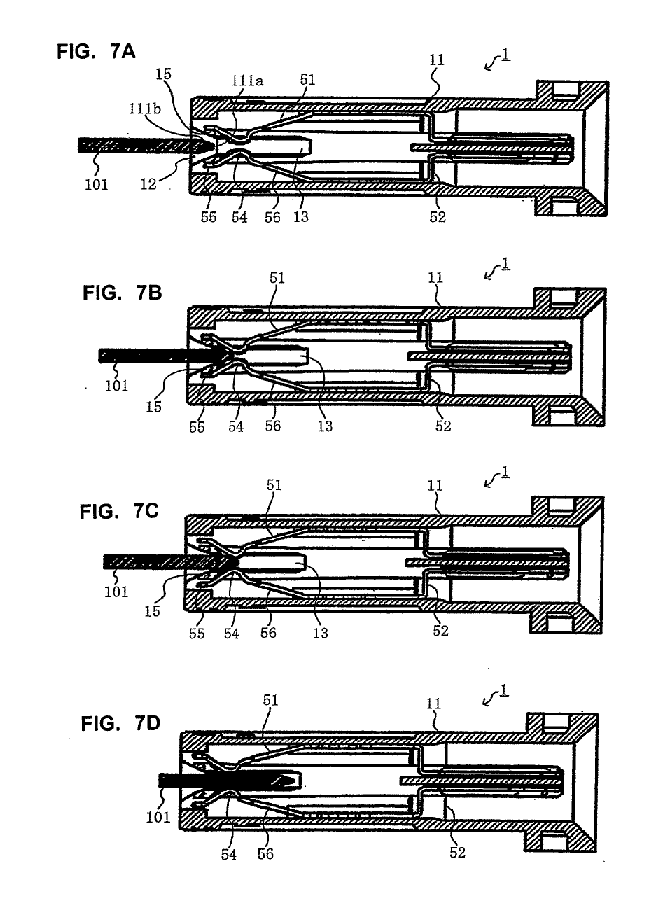

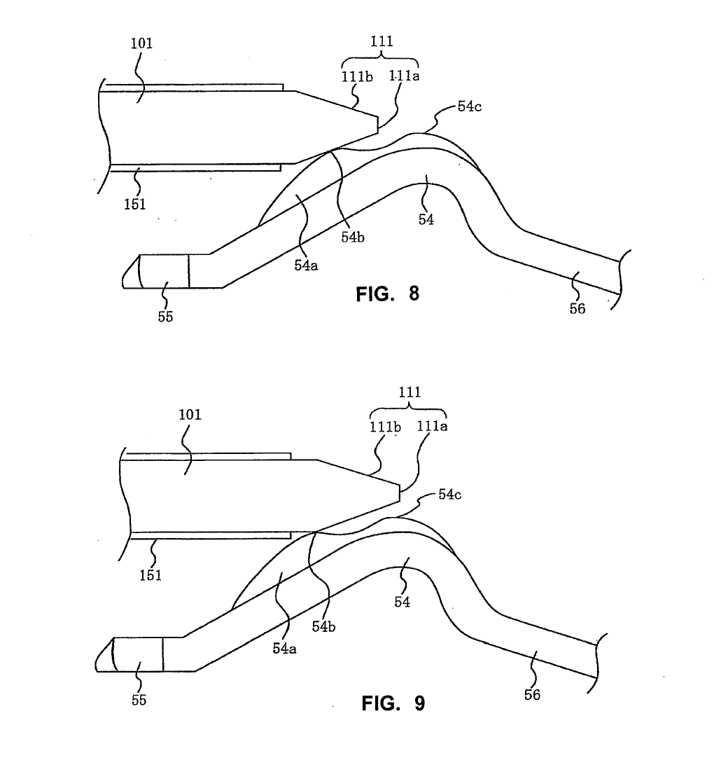

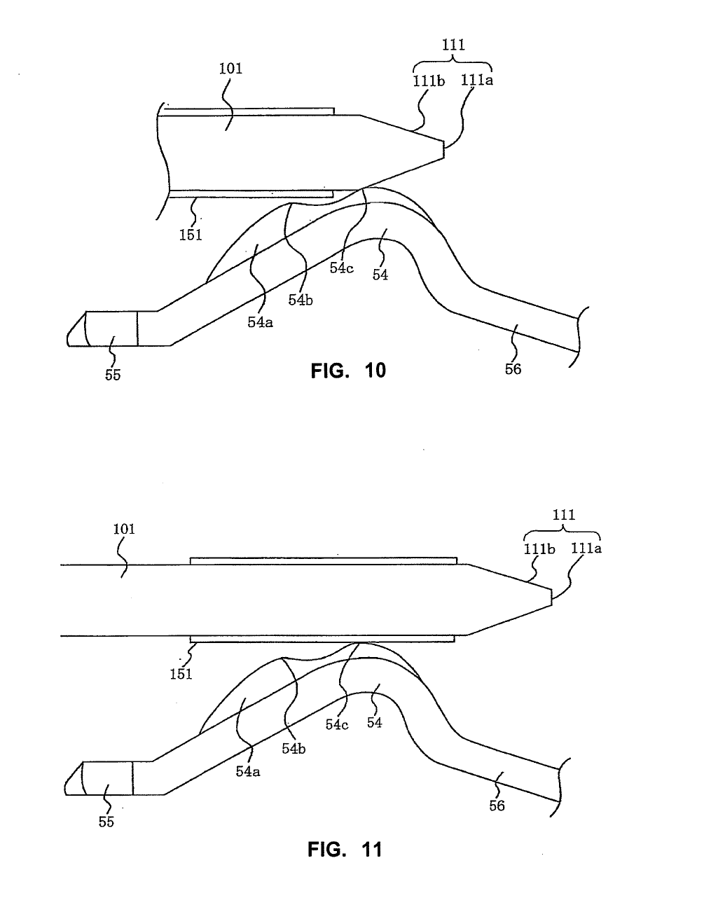

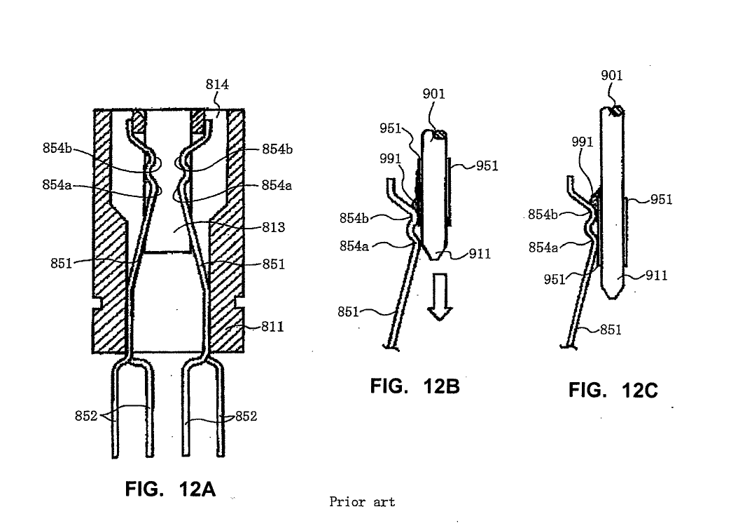

FIGS. 7A to 7D are cross-sectional views illustrating a sequence of movement of fitting the card edge connector with the card, according to the embodiment of the present invention. FIG. 8 is a first figure illustrating a positional relationship between the terminal of the card edge connector and the card, according to the embodiment of the present invention. FIG. 9 is a second figure illustrating a positional relationship between the terminal of the card edge connector and the card according to the embodiment of the present invention. FIG. 10 is a third figure illustrating a positional relationship between the terminal of the card edge connector and the card according to the embodiment of the present invention. FIG. 11 is a fourth figure illustrating a positional relation between the terminal of the card edge connector and the card according to the embodiment of the present invention. FIGS. 8 to 11 illustrate only one of the arm portions of the paired terminals arranged vertically while opposed to each other and do not illustrate the other.

The operator relatively moves a card 101 with respect to the connector 1 and inserts the tip portion 111 of the card 101 into the front recess part 12 opened at the end face of the front end 11a of the housing 11 as shown in FIG. 7A. When the operator further moves the card 101 toward the rear of the connector 1, the tip portion 111 of the card 101 moves between the upper and lower preload imparting portions 15 arranged at the front end of the card-accommodating groove part 13 and is inserted into the card-accommodating groove part 13. In this case, the tip portion 111 has a cross section converging toward the tip thereof, and the spacing between the upper and lower preload imparting portions 15 is set larger than the thickness dimension of the card 101, so that the tip portion 111 of the card 101 is smoothly inserted into the card-accommodating groove part 13.

When the operator further moves the card 101 toward the rear of the connector 1, the tip portion 111 of the card 101 advances between the bent portions 54 of the upper and lower terminals 51 and abuts against the bent portions 54 as shown in FIG. 7B. In this case, the tip portion 55 of the terminal 51 is engaged with the preload imparting portion 15 so that the spacing between the bent portions 54 of the upper and lower terminals 51 is somewhat increased thus causing the tip portion 111 of the card 101 to be smoothly inserted between the bent portions 54 of the upper and lower terminals 51.

When this state is observed microscopically, only the first apex portion 54b at the bent portion 54 is in contact with the tip portion 111 of the card 101 and the second apex portion 54c is not in contact with the tip portion 111 of the card 101 as shown in FIG. 8. This is because the first apex portion 54b is positioned closer to the tip portion 55 than the second apex portion 54c.

Next, when the operator further moves the card 101 toward the rear of the connector 1, the tip portion 111 of the card 101 further advances between the upper and lower bent portions 54 opposing to each other as shown in FIG. 7C. This increases the spacing between the bent portions 54 and causes the arm part 56 to be elastically deformed. That is, the upper and lower bent portions 54 opposing to each other are elastically deformed in a direction distant away from the center of the housing 11 in its thickness direction. This moves the tip portion 55 of the terminal 51 to be separated apart from the preload imparting portion 15.

When this state is observed microscopically, as shown in FIG. 9, the first apex portion 54b relatively slides rearward along the tapered surface 111b inclined, thus causing the bent portion 54 to be displaced downward in FIG. 9. The second apex portion 54c does not come into contact with the tip portion 111 of the card 101 in the meantime. This is because the first apex portion 54b is positioned closer to the tip portion 55 than the second apex portion 54c and the difference between the amount of protrusion of the first apex portion 54b and that of the second apex portion 54c is not so great. By adjusting the difference between the amount of protrusion of the first apex portion 54b and that of the second apex portion 54c, it is possible to make an arrangement so that only the first apex portion 54b will come into contact with the tapered surface 111b and the second apex portion 54c will not come into contact with the tapered surface 111b even in case the inclination angle of the tapered surface 111b has changed with the type of the card 101.

Furthermore, as shown in FIG. 10, when the first apex portion 54b relatively slides rearward along the surface of the connecting electrode 151, the second apex portion 54c comes into contact with only a local portion of the tapered surface 111b of the tip portion 111, that is, a portion of the tapered surface 111b on the side of the connecting electrode 151.

In this way, while only the first apex portion 54b is in contact with the tip portion 111 of the card 101, the second apex portion 54c does not come into contact with the tip portion 111 of the card 101. Thus, it is possible to prevent foreign substance, if any on the tip portion 111 of the card 101, from attaching to the second apex portion 54c. For example, even in case glass fibers or the like as a parent material of the card 101 are exposed on the tapered surface 111b, the glass fibers or the like may attach to the first apex portion 54b sliding along the tapered surface 111b but may scarcely attach to the second apex portion 54c. The second apex portion 54c scarcely slides along the tapered surface 111b as a coarse surface where glass fibers or the like are exposed so that the surface of the second apex portion 54c is free from damage application. For example, a plating film having a good conductivity coated on the second apex portion 54c does not peel off. Even in case any foreign substance has attached to the first apex portion 54b, the surface of the second apex portion 54c is neither contaminated with such foreign substance nor damaged, which maintains a clean and good conductivity state.

Next, when the operator further moves the card 101 toward the rear of the connector 1, a portion of a predetermine length from the tip edge 111a of the card 101 is inserted into the card-accommodating groove part 13, and the fitting between the connector 1 and the card 101 is completed as shown in FIG. 7D. Each of the bent portions 54 of the upper and lower terminals 51 comes into contact with a corresponding connecting electrode 151 on the upper or lower surface of the card 101. In this case, the card 101 advances between the upper and lower bent portions 54 opposing to each other, which increases the spacing between the bent portions 54 and causes the arm part 56 to be elastically deformed. The resulting elastically urging force presses each of the bent portions 54 against the corresponding connecting electrode 151. This reliably maintains the electrical connection between the terminal 51 and the connecting electrode 151. The upper and lower bent portions 54 sandwich therebetween the card 101, so that the fitting between the connector 1 and the card 101 is reliably maintained.

When this state is observed microscopically, only the second apex portion 54c of the bent portion 54 is in contact with the connecting electrode 151 of the card 101 and the first apex portion 54b is not in contact with the connecting electrode 151, as shown in FIG. 11. More specifically, the first apex portion 54b slides along the surface of the connecting electrode 151 while only a microscopic portion of the tapered surface 111b of the second apex portion 54c slides along the same. After that, when the second apex portion 54c comes into contact with the connecting electrode 151, the first apex portion 54b moves away from the connecting electrode 151. This is because the amount of protrusion of the second apex portion 54c is larger than that of the first apex portion 54b.

In this way, only the clean second apex portion 54c comes into contact with the connecting electrode 151 and the first apex portion 54b which may carry any foreign substance thereon scarcely comes into contact with the connecting electrode 151, thus preventing foreign substance from attaching to the connecting electrode 151. The first apex portion 54b which may carry foreign substance thereon scarcely rubs against the surface of the connecting electrode 151. Therefore, any application of damage to the surface of the connecting electrode 151 can be avoided. For example, a plating film having a good conductivity coated on the surface of the second apex portion 54c does not peel off. This eliminates the probability of foreign substances being interposed between the second apex portion 54c and the connecting electrode 151 and prevents the surfaces of the second apex portion 54c and the connecting electrode 151 from being damaged, thereby maintaining a clean and good conductivity state. This provides an excellent contact between the second apex portion 54c and the connecting electrode 151 and maintains an excellent electric connection therebetween.

Only the second apex portion 54c out of the two apex portions is in contact with the connecting electrode 151, thus generating no vibration, which reliably maintains the contact between the second apex portion 54c and the connecting electrode 151. Assuming that both of the first apex portion 54b and the second apex portion 54c are in contact with the connecting electrode 151, the urging force is dispersed into two sections since the swelling portion 54a where the first apex portion 54b and the second apex portion 54c are formed and the bent portion 54 are formed of an elastic plate member. Thus, the urging force per section is reduced and the resulting vibrations are likely to occur between the first apex portion 54b and the second apex portion 54c. Upon such vibrations, neither the first apex portion 54b nor the second apex portion 54c maintains contact with the connecting electrode 151, thus causing poor contact.

While two apex portions are formed on the swelling portion 54a in this embodiment, three or more apex portions may be formed. Any number of apex portions greater than one may be formed.

It is now assumed that three apex portions are formed. While one apex portion closest to the fitting end of the housing 11 to the card 101, namely, the front end 11a is in contact with the tip portion 111 of the card 101, the other two apex portions are not in contact with the tip portion 111 of the card 101, and while the two other apex portions are in contact with the tip portion 111 of the card 101, the apex portion closest to the front end 11a of the housing 11 is not in contact with the tip portion 111 of the card 101. An arrangement may also be made so that, while two apex portions closer to the front end 11a of the housing 11 are in contact with the tip portion 111 of the card 101, the other one apex portion is not in contact with the tip portion 111 of the card 101 and while the other one apex portion is in contact with the connecting electrode 151 of the card 101, the other two apex portions closer to the front end 11a of the housing 11 are not in contact with the connecting electrode 151 of the card 101.

In this way, according to this embodiment, a connector 1 has a housing 11 which is fitted with a card 101 including a connecting electrode 151 on each of both surfaces thereof and terminals 51, each including a plurality of apex portions in contact with both surfaces of the card 101, that is, a first apex portion 54b and a second apex portion 54c. The first apex portion 54b and the second apex portion 54c are arranged to form rows opposing to each other. The spacing between the first apex portion 54b and the second apex portion 54c on both sides is initially smaller than the thickness of the card 101. While the contact portion closer to the front end 11a of the housing 11 out of the first apex portion 54b and the second apex portion 54c, that is, the first apex portion 54b is in contact with the tip portion 111 of the card 101, only the first apex portion 54b is in contact. While the other contact portion, that is, the second apex portion 54c is in contact with the connecting electrode 151 of the card 101, only the second apex portion 54c is in contact with the connecting electrode 151.

This prevents the connecting electrode 151 and the second apex portion 54c from being contaminated with foreign substance on the tip portion 111 of the card 101 and the second apex portion 54c from being damaged. This ensures an excellent contact between the second apex portion 54c and the connecting electrode 151 and an electric connection between the terminal 51 and the connecting electrode 151.

The first apex portion 54b and the second apex portion 54c of each terminal 51 are arranged side by side in the front-and rear direction of the housing 11 and the amount of protrusion of the second apex portion 54c is larger than that of the first apex portion 54b. Thus, while the first apex portion 54b is in contact with the tip portion 111 of the card 101, only the first apex portion 54b is in contact and the second apex portion 54c is not contact with the same. While only the second apex portion 54c is in contact with the connecting electrode 151 of the card 101, the first apex portion 54b is not in contact with the same.

The terminal 51 has a main body 53 secured to the housing 11, a cantilever-like arm part 56 obliquely extending from one end of the main body 53, and a first apex portion 54b and a second apex portion 54c formed in a free end of the arm part 56.

An urging force generated by the arm part 56 presses the second apex portion 54c against the corresponding connecting electrode 151, thus reliably maintaining an electric connection between the terminal 51 and the connecting electrode 151. Both second apex portions 54c sandwich therebetween the card 101, thus reliably maintaining the fitting between the connector 1 and the card 101.

While the terminals 51 are arranged opposing to each other on the upper and lower sides of the housing 11 in the foregoing embodiment, the terminals 51 may be arranged only on the upper or lower side. The above-mentioned advantage is also obtained by providing the first apex portion 54b and the second apex portion 54c of the bent portion 54 of the terminal 51.

While a preferred embodiment of the Present Invention is shown and described, it is envisioned that those skilled in the art may devise various modifications without departing from the spirit and scope of the foregoing Description and the appended Claims.

What is claimed is:

1. A card edge connector comprising:
a connector main body configured to be fitted with a card provided with connecting electrodes; and
terminals loaded in the connector main body, each being configured to include a plurality of contact portions capable of coming into contact with the card;
wherein respective of the contact portions are arranged to form rows opposed to each other; and
when the contact portions out of the plurality of contact portions which are disposed closer to a fitting end of the connector main body with the card are in contact with a tip portion of the card, the other contact portions are not in contact with the same tip portion, and when the other contact portions are in contact with connecting electrodes of the card, the contact portions disposed closer to the fitting end are not in contact with the same connecting electrodes.

2. The card edge connector according to claim 1, wherein the plurality of contact portions of each of the terminals are arranged in a front-and-rear direction of the connector main body, and wherein in comparison with an amount of protrusion of the contact portion which is disposed closer to the fitting end of the connector main body with the card, that of protrusion of the other contact portion is configured to be larger.

3. The card edge connector according to claim 2, wherein the terminal has a main body secured to the connector main body, a cantilever-like arm part configured to extend obliquely from one end of the main body, and the plurality of contact portions formed in a free end part of the arm part.

4. The card edge connector according to claim 3, wherein each of the plurality of contact portions has a part of a swelling portion formed at a bent portion, which is bent so as to protrude toward a center of the connector main body in a thickness direction thereof and is formed at the free end part of the arm part.

5. The card edge connector according to claim 4, wherein at least a surface of the other contact portion out of the plurality of contact portions is formed thereon with a film having a good conductivity.

6. The card edge connector according to claim 5, wherein the plurality of contact portions comprises a first contact portion and a second contact portion.

7. The card edge connector according to claim 1, wherein the terminal has a main body secured to the connector main body, a cantilever-like arm part configured to extend obliquely from one end of the main body, and the plurality of contact portions formed in a free end part of the arm part.

8. The card edge connector according to claim 7, wherein each of the plurality of contact portions has a part of a swelling portion formed at a bent portion, which is bent so as to protrude toward a center of the connector main body in a thickness direction thereof and is formed at the free end part of the arm part.

9. The card edge connector according to claim 8, wherein at least a surface of the other contact portion out of the plurality of contact portions is formed thereon with a film having a good conductivity.

10. The card edge connector according to claim 9, wherein the plurality of contact portions comprises a first contact portion and a second contact portion.

11. The card edge connector according to claim 7, wherein at least a surface of the other contact portion out of the plurality of contact portions is formed thereon with a film having a good conductivity.

12. The card edge connector according to claim 11, wherein the plurality of contact portions comprises a first contact portion and a second contact portion.

13. The card edge connector according to claim 7, wherein the plurality of contact portions comprises a first contact portion and a second contact portion.

14. The card edge connector according to claim 8, wherein the plurality of contact portions comprises a first contact portion and a second contact portion.

15. The card edge connector according to claim 2, wherein at least a surface of the other contact portion out of the plurality of contact portions is formed thereon with a film having a good conductivity.

16. The card edge connector according to claim 15, wherein the plurality of contact portions comprises a first contact portion and a second contact portion.

17. The card edge connector according to claim 2, wherein the plurality of contact portions comprises a first contact portion and a second contact portion.

18. The card edge connector according to claim 3, wherein at least a surface of the other contact portion out of the plurality of contact portions is formed thereon with a film having a good conductivity.

19. The card edge connector according to claim 18, wherein the plurality of contact portions comprises a first contact portion and a second contact portion.

20. The card edge connector according to claim 3, wherein the plurality of contact portions comprises a first contact portion and a second contact portion.

21. The card edge connector according to claim 4, wherein the plurality of contact portions comprises a first contact portion and a second contact portion.

22. The card edge connector according to claim 1, wherein at least a surface of the other contact portion out of the plurality of contact portions is formed thereon with a film having a good conductivity.

23. The card edge connector according to claim 22, wherein the plurality of contact portions comprises a first contact portion and a second contact portion.

24. The card edge connector according to claim 1, wherein the plurality of contact portions comprises a first contact portion and a second contact portion.
